(19) United States
(12) Patent Application Publication
(10) Pub. No.: US 2015/0167935 A1
(43) Pub. Date: Jun. 18, 2015

(54) OPTICAL SYSTEM WITH ADJUSTABLE LIGHT BEAM FOR LED LIGHTING DEVICES

(71) Applicant: BEGHELLI S.p.A., Monteveglio (BO) (IT)

(72) Inventor: Gian Pietro Beghelli, Monteveglio (BO) (IT)

(21) Appl. No.: 14/405,385

(22) PCT Filed: May 31, 2013
(86) PCT No.: PCT/IT2013/000153

§ 371 Date: Dec. 3, 2014

(30) Foreign Application Priority Data
Jun. 5, 2012 (IT) VI2012A000134

(51) Int. Cl. F21V 14/06; F21K 99/00; F21V 7/06; G02B 27/30; F21V 5/00; F21V 13/04

(52) U.S. Cl. CPC F21V 14/06; F21V 5/008; F21V 5/007; F21V 13/04; F21V 7/06; G02B 27/30; F21K 9/50; F21Y 2101/02

(57) ABSTRACT

An optical system with adjustable light beam for LED lighting devices, having a single LED light source (1), composed of a single diode or a group of diodes, a first optical device (2), placed near said LED light source (1), and a second optical device (3), which is placed farther from said LED light source (1) with respect to said first optical device (2); said first optical device (2) is constituted by a complex optical element, within which refractions and reflections of the light rays exiting from said LED light source (1) and sent to said first optical structure (2) occur, so as to obtain a collimated light beam which is sent to a first array (7) of positive lenses that are placed below said first optical device (2).

The present invention generally relates to an optical system with adjustable light beam for lighting devices and LED light sources.

More particularly, the invention relates to an optical system configured to adjust the photometric emission (i.e. the output light intensity distribution) of a lighting apparatus with LED light sources.

Lighting devices have various features regarding their photometric emission which depend on their use; in particular, in the lighting and/or emergency lighting field, a large number of lighting devices have already been conceived regarding the design and the structure of lenses and/or reflectors configured to be coupled to LED light sources.

However, almost all said known optical systems are static, because they do not provide any mechanism for adjusting the light beam.

Furthermore, when a light beam adjusting mechanism is used, said mechanism usually works properly only in one working condition and it has low performance in all other working conditions.

An object of the present invention is therefore to obviate the drawbacks of the prior art mentioned above and, in particular, to provide an optical system with adjustable light beam for LED lighting devices, which allows to obtain a light beam which can be adjusted between a condition of maximum collimation and a condition of maximum angular opening.

Another object of the present invention is to provide an optical system with adjustable light beam for LED lighting devices which is configured to obtain a high and almost constant luminous efficiency with respect to a parameter defining the angular width of the light beam.

Another object of the invention is to provide an optical system with adjustable light beam for LED lighting devices which is configured to obtain maximum luminance uniformity within the bright spot and minimal chromatic aberrations.

A further object of the invention is to provide an optical system with adjustable light beam for LED lighting devices which is easy and economical to manufacture and which can be made without using complex and/or expensive technologies.

These and other objects are achieved by an optical system with adjustable light beam for LED lighting devices according to the appended claim 1; other technical features of the optical system according to the invention are provided in the dependent claims.

Advantageously, the optical system according to the invention is made as a generic device that can be used as a component in many lighting systems, without being bound to a specific lighting device or application.

Further objects and advantages of the present invention will become clear from the foregoing description, which refers to a preferred embodiment of the optical system with adjustable light beam for LED lighting devices, object of the present invention, and from the enclosed drawings, in which:

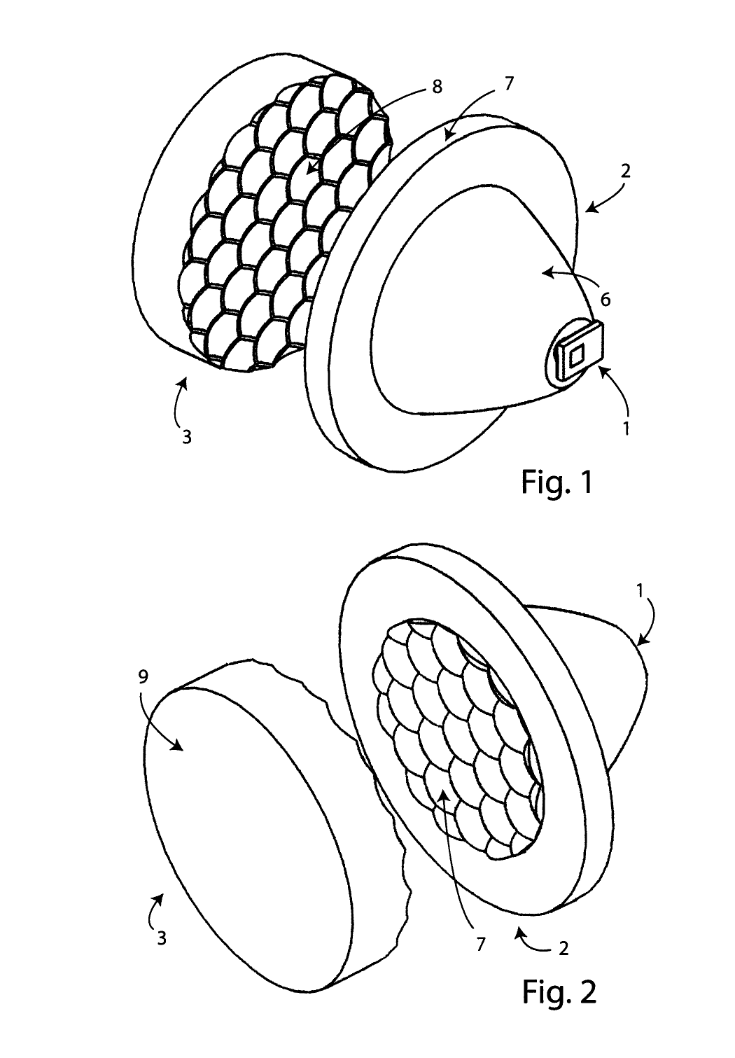

FIG. 1 is a first exploded view of the optical system with adjustable light beam for LED lighting devices according to the present invention;

FIG. 2 is a second exploded view of the optical system with adjustable light beam for LED lighting devices according to the present invention;

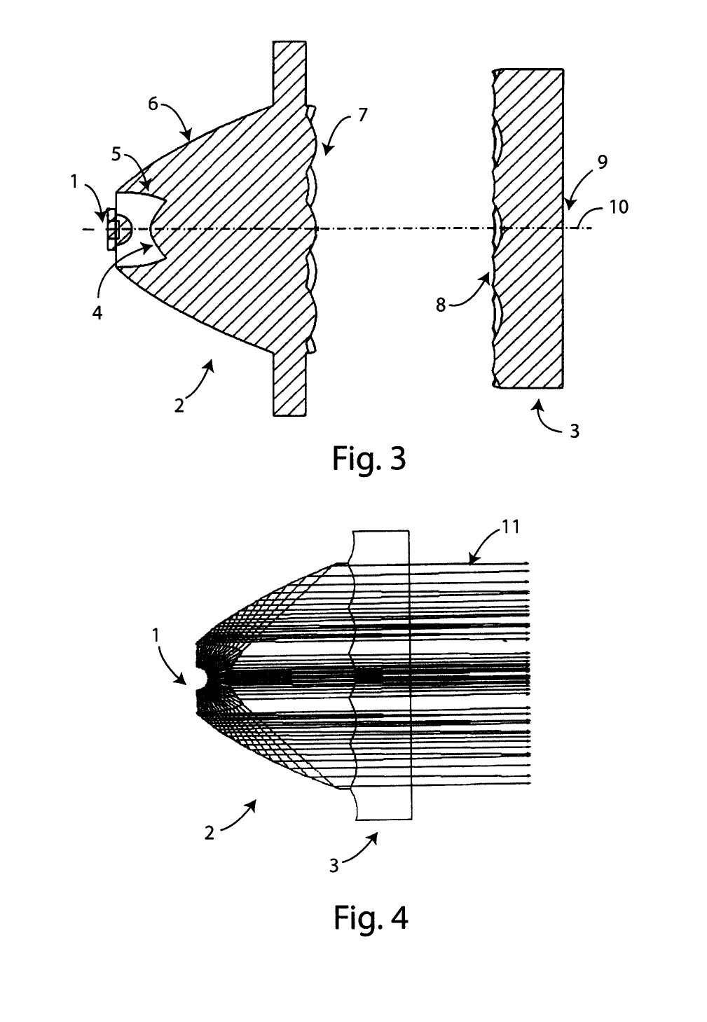

FIG. 3 is a sectioned and exploded view of the optical system with adjustable light beam for LED lighting devices according to the present invention;

FIGS. 4, 5 and 6 show the course of the light beam in various configurations of the optical system according to the present invention.

With reference to the above figures, the optical system with adjustable light beam, which is the object of the present invention, is configured to be used in lighting devices comprising a single light source 1; said single light source can be constituted by a single LED or by a plurality of LEDs.

In any case, the light source 1 can be considered as a quasi-point emitter.

The optical system of the invention is composed of three parts, namely the LED light source 1, a first optical device 2 which is placed near the LED light source 1, and a second optical device 3 which is placed far away the LED light source 1.

Both the first optical device 2 and the second optical device 3 are made of a refractive transparent material and, specifically, the first optical device 2 is an complex optical component within which optical refractions and reflections are carried out.

The light rays exiting the LED light source 1 and sent towards the first optical device 2 are refracted by the refractive interface 5 and, in particular, a portion of said rays, which is closer to the optical axis 10, is collimated by the lens 4, while the remaining portion is refracted by the interface's surface 5, which constitutes a virtual light source in the focus of the parabolic profile of the reflector 6.

The TIR-type parabolic reflector 6 is configured to collimate the light rays so that they are parallel to the optical axis 10 and the surface of the reflector 6 is able to reflect light by means of a complete internal reflection.

In fact, the light emitted from the LED light source 1 is completely collimated; a first portion of said light is collimated from the surface of the lens 4 and the remaining portion is collimated from the surface of the parabolic reflector 6, before said light is sent to the array 7 of positive lenses, which is placed below the parabolic reflector 6.

Each positive lens of the array 7 is able to transform the portion of the collimated beam which is sent on said lens in a convergent beam, which is sent to a corresponding array 8 of negative lenses of the second optical device 3.

Moreover, the second optical device 3 includes two reflective interfaces and, in particular, is composed by the array 8 of negative lenses and by the flat interface 9.

The array 8 of negative lenses is a surface which is geometrically equal to the array 7 of positive lens, but said array 8 differs from the array 7 from an optical point of view, as it has a reversed order of the refraction indexes, so that the surface of the array 8 of negative lenses contains air in correspondence of the portion nearest to the LED light source 1 and a refractive element at the portion farthest from said LED light source 1.

The collimated beam which is sent to the array 7 of positive lens is characterized by a non-uniform luminance on a plane which is perpendicular to the optical axis 10.

Furthermore, each surface of the optical arrays 7 and 8 comprises a group of lenses and not a single lens, so as to obtain a uniformity of illumination of the light spot on a screen placed perpendicular to the optical axis 10 at a great distance from the optical system. Specifically, the arrays 7 and 8 are constituted by identical aspheric lenses (convex lenses are provided for the array 7, while concave lenses are provided for the array 8), which are arranged on a regular hexagonal or square grid, and each pair of lenses of the arrays 7, 8 is able to split the collimated beam sent on the lenses surface.

Thus, at a great distance from the optical system, the partial light beams, which are produced by each pair of lenses, overlap and therefore non-uniformities of each single partial light beam are canceled.

Furthermore, the optical system of the invention is equipped with a system for adjusting the angular amplitude of the light beam, since the relative position between the LED light source 1 and the first optical device 2 is fixed, while the second optical device 3 can move, with respect to the optical system, along the optical axis 10 (even if said second optical device 3 cannot rotate around the axis 10).

Thus, the distance between the surfaces of the optical arrays 7, 8 can vary from a minimum value equal to zero to a maximum value equal to twice the focal distance of the lenses placed in the array 7 of positive lenses.

Said two different optical configurations constitute an optical acromatism of the optical subsystem constituted by the surfaces or by the interfaces of the lenses arrays 7, 8.

In particular, when the first optical device 2 and the second optical device 3 are placed at a minimum distance between them, the two surfaces of the arrays 7, 8 are matched (as shown in the enclosed FIG. 4) and the array 8 of negative lenses cancels the effect of the array 7 of positive lenses and the collimated light beam 11 passes through the pair of arrays 7, 8 without any geometrical or chromatic changes; also, because the end interface 9 is flat, the light beam 11 exiting the optical system is perfectly collimated.

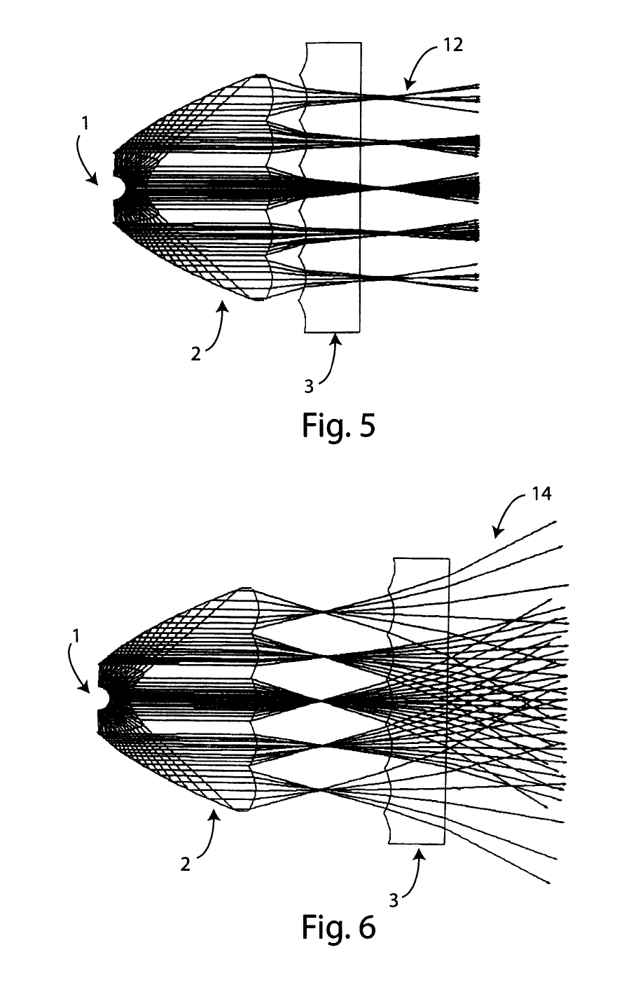

If the distance between the first optical device 2 and the second optical device 3 is increased (as shown, for example, in the enclosed FIG. 5), both the arrays 7, 8 of positive and negative lenses make changes to the light beam; in particular, the opening angle of the light beam 12 exiting from the optical system increases as the distance between the first optical device 2 and the second optical device 3 increases, up to a condition of maximum distance and maximum opening angle of the light beam 14 (as shown in the FIG. 6).

When the LED light source 1 is considered a point source, the optical system according to the present invention has a maximum luminous efficiency (except for the losses due to the Fresnel laws that occur near the interfaces of the arrays 7, 8); the luminous efficiency is also constant even if the distance between the first optical device 2 and the second optical device 3 is changed.

Beyond the maximum distance between the first optical device 2 and the second optical device 3, a vignetting effect occurs, resulting in loss of efficiency.

Finally, considering a real LED light source 1, the optical system of the present invention substantially acts as an optical system having a point light source if the light source is small, with respect to the other portions of the optical system.

The technical features of the optical system with adjustable light beam for LED lighting devices, which is the object of the present invention, is clear from the above description, as well as the technical advantages with respect to the prior art are also clear.

Finally, it is also clear that other technical features may be added to the optical system of the invention, without departing from the novelty principles of the inventive idea according to the appended claims, as it is clear that in the practical implementation of the invention, the materials, the shapes and the dimensions of the technical details which are shown may be any according to requirements and they can be replaced with other details that are technically equivalent.

1-14. (canceled)

15. Optical system with adjustable light beam for LED lighting devices, comprising a single LED light source (1), composed of a single diode or by an aggregate of diodes, a first optical structure (2), placed near said LED light source (1), and a second optical structure (3), which is farther from said LED light source (1) with respect to said first optical structure (2), wherein said first optical structure (2) is constituted by a complex optical component, in which refractions and reflections of the light rays exiting from said LED light source (1) and incident on said first optical structure (2) occur, so as to obtain a collimated light beam which is incident on a first array (7) of positive lenses that are placed at the base of said first optical structure (2), each of said positive lens of said first array (7) being able to transform a portion of the collimated light beam incident on said first array (7) into a convergent light beam, which is incident on a corresponding second array (8) of negative lenses of said second optical structure (3), characterized in that the relative positions between said LED light source (1) and said first optical structure (2) are fixed, while said second optical structure (3) is able to translate, with respect to said first optical structure (2), along said optical axis (10), so that the distance between the surfaces of said arrays (7, 8) of lenses varies from a minimum value to a maximum value, and in that said minimum value is equal to zero, while said maximum value is equal to twice the focal distance of the lenses that are placed inside said first array (7) of positive lenses.

16. Optical system according to claim 15, characterized in that said first optical structure (2) and said second optical structure (3) are made of the same transparent refractive material.

17. Optical system according to claim 15, characterized in that the light rays exiting from said LED light source (1) and incident on said first optical structure (2) are subjected to a first refraction on a refracting interface (5) of said first optical structure (2) and a first portion of said light rays, which is closer to the optical axis (10) passing through said LED light source (1) and perpendicular to said arrays (7, 8) of lenses, is collimated by a collimator lens (4) placed in front of said LED light source (1), while a remaining portion of said light rays is refracted by said refracting interface (5), which is able to carry out a virtual source in the focus of a parabolic reflector (6) placed above said first array (7) of positive lenses.

18. Optical system according to claim 15, characterized in that said parabolic reflector (6) collimates the light rays parallel to said optical axis (10) and the surface of said reflector (6) makes a light reflection by means of a total internal reflection.

19. Optical system according to claim 15, characterized in that the light rays emitted from said LED light source (1) are completely collimated, partly by the surface of said collimator lens (4) and partly by the surface of said parabolic reflector (6), before they are incident on said first array (7) of positive lenses.

20. Optical system according to claim 15, characterized in that said second optical structure (3) comprises two refracting interfaces and, in particular, said second array (8) of negative lenses and a flat end interface (9), which is associated with said second array (8) of negative lenses.

21. Optical system according to claim 15, characterized in that said second array (8) of negative lenses has a surface which is geometrically equal to the surface of said first array (7) of positive lenses.

22. Optical system according to claim 15, characterized in that said second array (8) of negative lenses is before air, which is located at a portion closest to said LED light source (1), and includes a refractive means, which is placed in correspondence with a portion that is farthest with respect to said LED light source (1).

23. Optical system according to claim 15, characterized in that said collimated beam incident on said first array (7) has a non-uniform luminance on a plane which is perpendicular to said optical axis (10).

24. Optical system according to claim 15, characterized in that said arrays (7, 8) of lenses include identical aspherical convex and concave lenses, which are arranged on a regular hexagonal or square grid, so that each pair of lenses of said arrays (7, 8) makes a division of said incident collimated light beam.

25. Optical system according to claim 15, characterized in that, when said value is minimum, the surfaces of said arrays (7, 8) of lenses coincide with each other and said light beam (11) passes through those arrays (7, 8) of lenses without changing its color or its geometry and is also collimated by said flat end interface (9).

26. Optical system according to claim 15, characterized in that said light beam (12, 14) outgoing from said flat end interface (9) has an opening angle which increases as the distance existing between said first optical structure (2) and said second optical structure (3).
